(19) United States
(12) Patent Application Publication
(10) Pub. No.: US 2004/0077413 A1
(43) Pub. Date: Apr. 22, 2004

(54) Method for constructing an enhanced strength composite drive shaft

(75) Inventors: Douglas J. Bradley, Howell, MI (US); Brian E. Carlson, Royal Oak, MI (US)

Correspondence Address: Michael A. Massing, BRINKS HOFER GILSON & LIONE, P.O. BOX 10395, CHICAGO, IL, 60610, US

(73) Assignee: Visteon Global Technologies

(21) Appl. No.: 10/681,779

(22) Filed: Oct. 8, 2003

Related U.S. Application Data
(62) Division of application No. 10/017,440, filed on Dec. 14, 2001.

(51) Int. Cl. F16C 3/00

(52) U.S. Cl. 464/181

(57) ABSTRACT

There is provided a composite drive shaft with enhanced strength characteristics, comprising a plurality of features placed in a composite drive shaft formed from composite fibrous material. A method for making the composite drive shaft is also provided, where a first later of composite fibrous material is applied around a cylindrical mold with receiving grooves. Features are pushed through the composite material into the receiving grooves. A second layer of composite fibrous material is wrapped around the first layer, the drive shaft is consolidated, and the cylindrical mold is removed. Also provided is a method for making a composite drive shaft wherein the features are inserted into the cylindrical mold and then pushed through the first layer of composite fibrous material after said layer is wrapped around the mold and the features.

The present application is a divisional of U.S. patent application Ser. No. 10/017,440, filed on Dec. 14, 2001, and is incorporated by reference in this patent application.

### FIELD OF THE INVENTION

This invention relates to a composite drive shaft for a vehicle with enhanced strength, and a method of making said drive shaft. More particularly, it relates to a composite drive shaft that has been enhanced for resistance to compressive forces, especially when undergoing a swaging process.

### BACKGROUND OF THE INVENTION

The output of a vehicle transmission is transmitted through a drive shaft to other gears and parts of the vehicle machinery. A drive shaft therefore often turns at a very high rate of speed and is subject to very high torsional forces. In order to help distribute the load of these forces, a drive shaft may be swaged to a connecting or end piece.

A drive shaft has conventionally been made of steel or other metallic substances. While providing proper strength to withstand the torsional forces put on it during use, these shafts are often heavy. A larger magnitude of power is therefore generally required to start and maintain the proper torsional speed. Additionally, metallic components can be expensive. Light weight materials have therefore been used in order to reduce the power requirements.

Additionally, lightweight materials give the drive shaft a higher critical speed. All drive shaft materials have an internal resonance frequency based in part on the weight of the material. If the drive shaft reaches that material's resonance frequency, the drive shaft will begin to shake. The resonance frequency of the material used thereby determines the top speed of operation, or critical speed, of the drive shaft. A lighter material increases the resonance frequency, and therefore the critical speed, of a drive shaft.

To such end, composite fiber drive shafts have been proposed. This has solved the problems of power and expense, but composite material can often be brittle. Thus, composite materials are difficult to manipulate after curing processes, including during swaging.

The process of swaging is one common in metallurgy. A given shaft can be swaged to another shaft of differing diameter by expanding or contracting the diameter at the end of the shaft. This is achieved via a mechanical process that plastically deforms the shaft uniformly in a radial direction. The swaged shaft contacts the other shaft to which it is to be connected, and presses into it, forming a strong connection.

While swaging is an effective method for making a secure connection between two shafts, it requires that the shaft to be swaged be plastically deformable, and not brittle. This compliance requirement is generally found in metallic components and pure polymeric components; however, a shaft made of a composite material is generally brittle and unable to withstand the compressive deformation load applied in the process of swaging.

Other methods of connection for composite shafts have been investigated. Special knurling of the component to which it is connected has been machined, and interlock achieved. In some instances, pins or other such connectors have been used to make a connection between a metallic sleeve and the composite shaft.

### BRIEF SUMMARY OF THE INVENTION

According to one aspect of the present invention, there is provided a composite drive shaft with enhanced strength characteristics. The composite drive shaft comprises a plurality of features perpendicular to the axis of a cylindrical mold having receiving grooves extending parallel to its axis to receive the features and composite fibrous material extending around the cylindrical mold and features to hold said features in place.

According to another aspect of the present invention, there is provided a method for making a composite drive shaft with enhanced strength characteristics. An elongated, cylindrical mold having at least one receiving groove is provided and a first layer of composite fibrous material is applied circumferentially around said mold. At least one feature is radially inserted through the first layer of composite fibrous material into the receiving grooves in the mold. A second layer of composite fibrous material is applied over the first layer of composite fibrous material and the features. The drive shaft is consolidated and the cylindrical mold is removed from the composite drive shaft.

According to yet another aspect of the present invention, there is provided a method for making a composite drive shaft with enhanced strength characteristics. An elongated, cylindrical mold defining at least one receiving groove is provided and at least one feature is radially inserted into the receiving grooves in the mold. Each feature comprises a head piece and an anchor piece. A first layer of composite fibrous material is applied circumferentially around the mold and the features, and the head pieces of the features are pushed through the first layer of composite fibrous material. A second layer of composite fibrous material is applied over the first layer of composite fibrous material and the features. The drive shaft is consolidated, and the cylindrical mold is removed from the center of the composite drive shaft.

Other aspects of the present invention will become apparent in connection with the following description of the present invention.

### BRIEF DESCRIPTION OF SEVERAL VIEWS OF THE DRAWINGS

FIG. 1A is an enlarged side view of two tubes before swaging, from the prior art;

FIG. 1B is an enlarged side view of two tubes after an outward swaging, from the prior art;

FIG. 1C is an enlarged side view of two tubes after an inward swaging, from the prior art;

FIG. 2 is one embodiment of a cylindrical mold with a sample receiving groove according to the present invention;

FIG. 3A is one embodiment of a feature according to the present invention;

FIG. 3B is a cross-sectional view of one embodiment of a composite drive shaft according to the present invention with sample forms of features inserted;

FIG. 4A is an enlarged side view of two shafts, one an embodiment of an enhanced shaft with a feature, according to the present invention, before swaging;

FIG. 4B is an enlarged side view of two shafts, one an embodiment of an enhanced shaft with a feature, according to the present invention, after an outward swaging;

FIG. 5 is a cross-sectional view of one embodiment of a finished shaft according to the present invention with a single feature inserted;

FIG. 6 is a flow diagram illustrating one method of making a composite drive shaft according to the present invention;

FIG. 7 is a cross-sectional view of one embodiment of a finished shaft according to the present invention with a plurality of ring-section-shaped features inserted; and

FIG. 8 is a side view of one embodiment of a finished shaft according to the present invention, without the second layer of composite fibrous material, with a plurality of ring-section shaped features inserted.

### DETAILED DESCRIPTION OF THE INVENTION

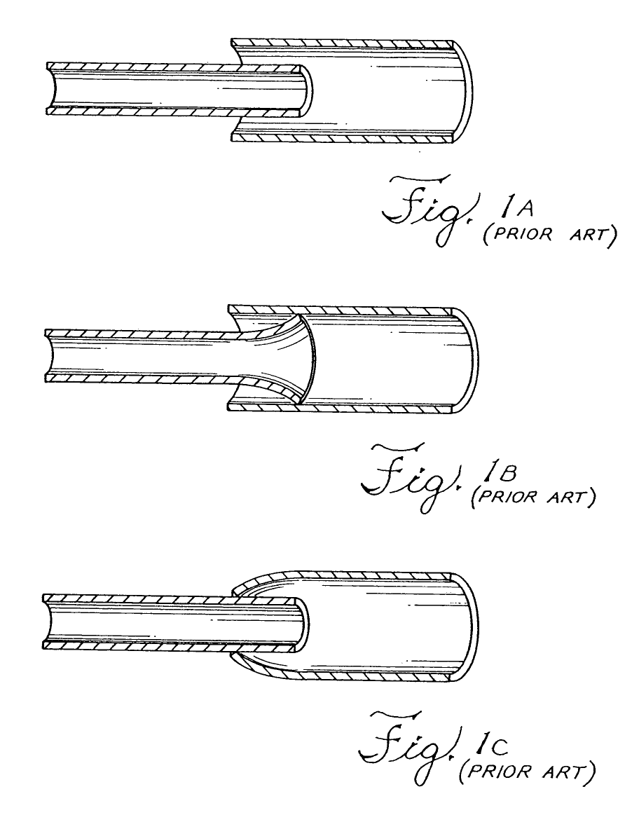

Swaging, the end-use of the present invention, is the process of increasing or decreasing the diameter of one tube in order to create an interlock with a second, larger or smaller tube. Such a process is portrayed in FIGS. 1A-1C. FIG. 1A shows a smaller tube 22 and a larger tube 24 before the swaging process is begun. Swaging in this situation can occur in one of two directions. FIG. 1B depicts an outward swaging, wherein the diameter of the smaller tube 22 is increased so as to engage that of the larger tube 24. The deformation of the smaller tube 22 into the larger tube 24 creates a contact point 26 that is both a frictional contact and a deformational contact. This contact point 26 provides for a more secure and strengthened connection between the two tubes. Alternately, as shown in FIG. 1C, the diameter of the larger tube 24 could be decreased so that it engages the outside of the smaller tube 22. Again, the deformation of the larger tube 24 into the smaller tube 22 creates a contact point 28 that is both a frictional contact and a deformational contact. This provides for a more secure and strengthened connection between the two tubes 22 and 24.

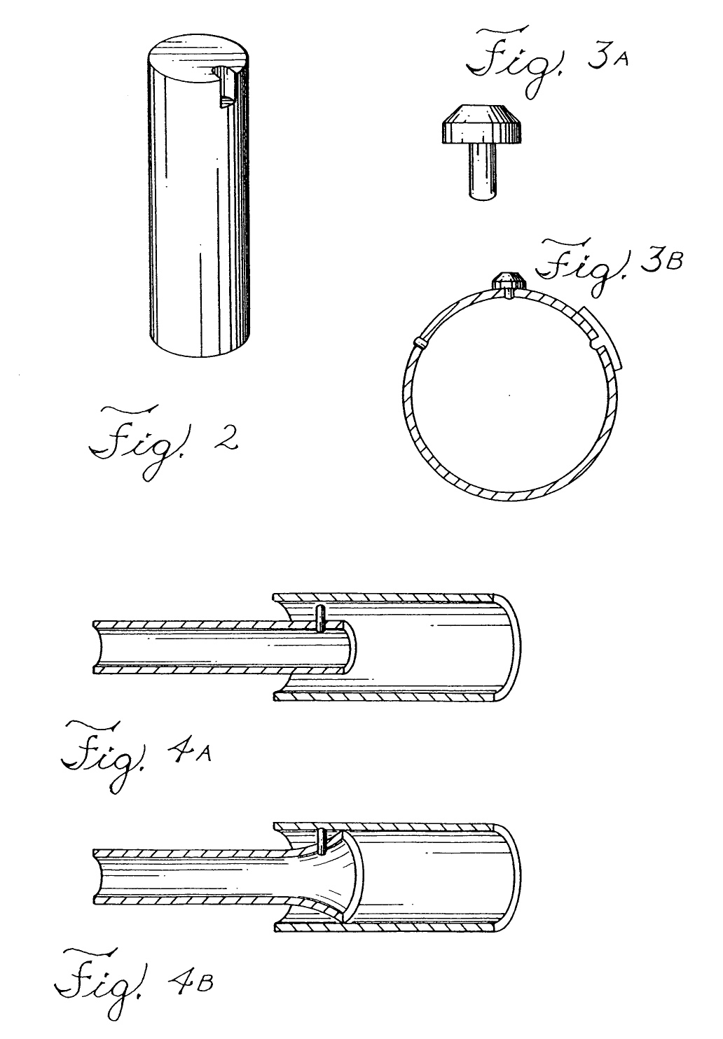

FIG. 2 illustrates one embodiment of a cylindrical mold 10 for use in the present invention. The cylindrical mold 10 is used to construct a composite drive shaft that has a number of integrated structures, or “features”, that bear some of the compressive stress load when a compressive stress is placed on the composite drive shaft. According to one embodiment, the cylindrical mold 10 is made of steel or another durable metal to provide structural thickness and support. More specifically, a ¼″ thick steel has been found to work particularly well in the present invention. However, any material that will not adhere, cure, or otherwise bond itself to the composite drive shaft would be an appropriate material for the cylindrical mold 10.

The cylindrical mold comprises one or more receiving grooves 12 cut into the side of the cylindrical mold 10. The length of each of the receiving grooves 12 is preferably a portion of the length of the cylindrical mold 10. The receiving grooves 12 are designed to accept the end of a feature 17.

Such features 17 are illustrated in FIG. 3A. A feature 17 has two sections: a head piece 15 and an anchor piece 16. FIG. 3B displays examples of potential features inserted into a drive shaft 14. The head piece 15 can be of any shape or design. Three preferred embodiments, shown in FIG. 3B, are headed stud 18, straight pin 19, or ring-section shaped 20 head pieces 15, have been shown to be particularly effective.

The anchor piece 16 is the portion of the feature 17 that is inserted into the drive shaft 14. The anchor piece 16 can be merely a straight cylindrical structure. However, structural modifications may be made to the anchor piece 16 to allow the feature 17 to anchor more securely to the drive shaft 14. Such modifications could include hooks, fins, screw threading, or knurled edges.

The features 17 as depicted are merely illustrative and do not suggest limits as to the shapes of features possible. For the purposes of this invention, the general term “feature” may be portrayed in the figures as referring to a certain shape of feature. However, the term should be construed as referring to any possible shape unless the shape is expressly specified. A single drive shaft 14 may have many features 17 of all the same kind, or features 17 of different types on a single shaft.

The receiving grooves 12 will accept the anchor piece 16 end of a feature 17 placed into the created drive shaft 14, and allow the cylindrical mold 10 to be removed from the finished drive shaft 14 with the feature 17 still in place. These receiving grooves 12 could run the entire length of the cylindrical mold 10, but need only be long enough to allow a feature 17 to be placed into the drive shaft at the desired position and have the anchor piece 16 be accepted into the receiving groove 12. If a feature 17 has a small anchor piece 16, the cylindrical mold 10 may not require a receiving groove 12.

The feature 17 serves at least two purposes in strengthening the drive shaft 10. First, a composite material with a solid particle in the composite matrix, such as a feature 17, will exhibit enhanced compressive strength. Such enhanced strength improves the composite's performance through the swaging process. When a stress is placed on a uniform drive shaft 14, that stress is transmitted throughout the entire drive shaft 14 evenly. If the magnitude of the stress is greater than that of the material used to construct the drive shaft 14, the drive shaft 14 will break. Composite materials have a low plasticity. The action of swaging, as discussed below, requires a material with a higher compressive strength and plasticity than composite materials typically possess. Therefore, while swaging would be an useful method for joining a drive shaft 14, swaging often cannot be used when the drive shaft is made out of a composite material.

However, when a drive shaft 14 has additional features 17 inserted, the distribution of stresses is modified. Instead of the compressive stress being distributed uniformly throughout the composite material of the drive shaft 14, the stress is focused at the features 17. The features 17, since they have more compressive strength than the composite material, can more effectively support the stress placed on the drive shaft than the composite material. The stress forces, instead of being only borne by the composite material, are borne disproportionately by the features 17. The stress is thereby more easily dispersed and sustained by the strong metallic features 17 than the more brittle composite material of the drive shaft 14.

Secondly, as will be discussed below, swaging of a composite drive shaft 30 with one or more features 17 added thereto provides a second contact point for interlock between the composite drive shaft 30 and the shaft to which it is swaged. Whereas swaging a uniform composite drive shaft 30 only provides contact at the end of the shaft, the addition of the feature allows for engagement at the head piece 15 of the feature 17. An additional place for engagement and deformation will cause a more secure and strengthened connection.

FIGS. 4A and 4B demonstrate how the feature 17 in one embodiment of the composite drive shaft 30 effects a more effective swaging than the prior art interfacing of FIGS. 1A-1C. FIG. 4A shows an embodiment of a composite drive shaft 30 with a single inserted feature 17, as discussed below. It is desired to connect the shaft with a metal sleeve 24 with a larger radius. The composite drive shaft 30 is swaged in an outward direction, so that the radius of the composite drive shaft 30 is increased. During swaging, the added feature 17 allows swaging to occur without breaking the composite drive shaft 30. The composite drive shaft 30 is swaged until the end of the composite drive shaft 30 and the feature 17 come into contact with the metal sleeve 24, engaging it and deforming into it. After the swaging process, the resulting assembly is illustrated in FIG. 4B. A contact point 32 here is formed not only where the end of the composite drive shaft 30 touches the outer metal sleeve 24, but also at the point of insertion of the feature 17. This provides a more secure and strengthened connection, both because of the two points of contact 32 and because of the deformation of the composite drive shaft 30 into the metal sleeve 24. The composite drive shaft 30 and the metal sleeve 24 are therefore less likely to disengage during typical use.

In FIG. 5, a finished composite drive shaft 30 is illustrated, still on the cylindrical mold 10, with only a single feature 17. The finished composite drive shaft consists of a first layer of composite fibrous material 34, also called the shaft body, applied around the cylindrical mold 10, a feature 17 inserted through the first layer of composite fibrous material 34 into a receiving groove 12 in the cylindrical mold 10, and a second layer of composite fibrous material 36 applied around the whole assembly.

The method of making such a composite drive shaft 30 is shown in the flow diagram of FIG. 6. The method comprises first providing the cylindrical mold 10 at box 110. A first layer of composite fibrous material 34 is applied around the cylindrical mold 10 at box 120. At least one feature 17 is inserted through the first layer of composite fibrous material 34 into receiving grooves 12 in the cylindrical mold 10 at box 130. A second layer of composite fibrous material 36 is then applied over the whole assembly at box 140, and a finishing method consolidates the entire composite drive shaft 30 at box 150. The cylindrical mold 10 is removed from the center of the finished composite drive shaft 30 at box 160.

The composite fibrous material layers 34 and 36 are preferably composed of one or more carbon fiber sheets each. The carbon fiber sheet is preferably pre-impregnated with composite fibers and resin to facilitate curing of the sheet after wrapping. The carbon fibers used are preferably unidirectional, as that fiber orientation provides the greatest amount of strength. Such a sheet can be obtained commercially, and are available in a variety of thicknesses. A wide range of thicknesses is successful in the present invention. Particular success has been obtained with sheets that are approximately 0.008″ thick.

While a pre-impregnated sheet of composite fibers is a preferred method of applying the layers of composite fibrous material 34 and 36, these layers may also be applied using filament winding or braiding methods. These methods are generally known to those of ordinary skill in the art.

As earlier shown in FIG. 3B, the feature 17 can be of any shape. The step of feature insertion at box 130 can come before or after the first layer of composite fibrous material 34 is wrapped around the cylindrical mold 10 at box 120. The feature 17 can be pushed into the first layer of composite fibrous material 34 by hand, or a drill or other mechanical device may be used to push the feature 17 through the first layer of composite fibrous material 34. Additionally, while it is preferred that the feature 17 be inserted after the first layer of composite fibrous material 34 is wrapped around the cylindrical mold 10, there are some cases in which it would be preferable to insert the feature 17 first. In such a case, the first layer of composite fibrous material 34 would be cured, and an opening created in the first layer of composite fibrous material 34 to insert the feature 17 through as the first layer of composite material 34 is being wrapped. The first layer of composite fibrous material 34 may also be pushed around the feature 17. Regardless of the manner in which the feature 17 and first layer of composite fibrous material 34 are joined, it may be advantageous to ensure that the joint is secure. In order to achieve a higher level of security in the joint, an adhesive polymer, such as an epoxy-based adhesive, may preferably be placed around the feature 17 before the second layer of composite fibrous material 36 is wrapped around the cylindrical mold 10 at box 140 to help securely bond the feature 17 to the first layer of composite fibrous material 34.

The consolidation at box 150 may proceed in one of many ways, as known to those of ordinary skill in the art. The consolidation may occur by shrink-wrapping the composite drive shaft 30, thus allowing it to cure and adhere together. Such a commercially available shrink-wrap is preferably made of polyester, polyethylene, polypropylene, polyamide polymers, polyimide polymers, other thermoplastic polymers, or a combination of the above. The choice of which polymeric material can be made based on what material is easily available to the manufacturer as well as cost. A vacuum-bag assembly may also be used to consolidate the composite drive shaft 30 using vacuum pressure. In the alternative, a bladder molding assembly or a female mating tool consolidates the composite drive shaft 30 via mechanical pressure. The whole composite drive shaft 30 may be treated by a traditional chemical curing process. Other methods of consolidating the composite drive shaft 30, as known to one of ordinary skill in the art, can be chosen based on the materials used, as well as the budget and facilities available to the manufacturer.

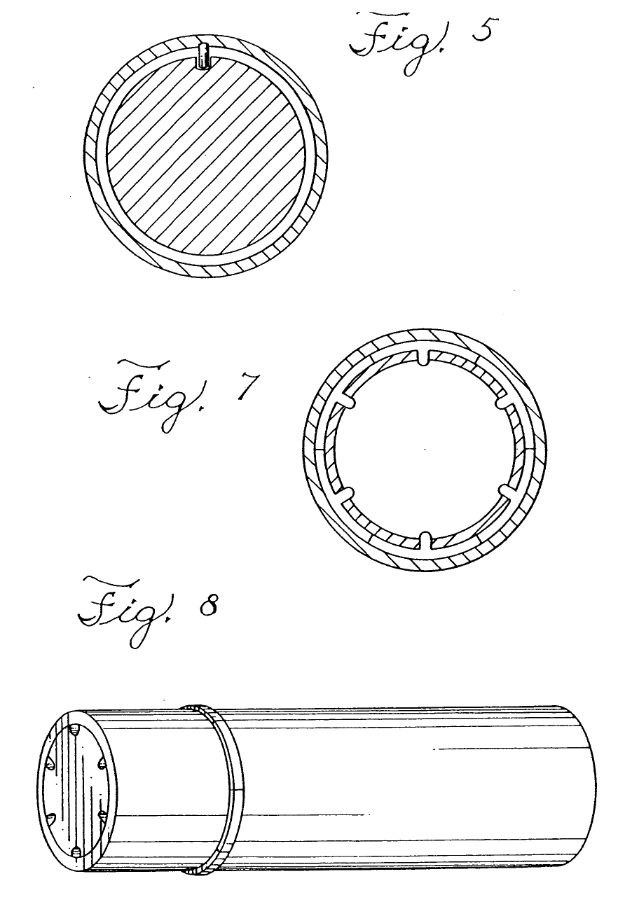

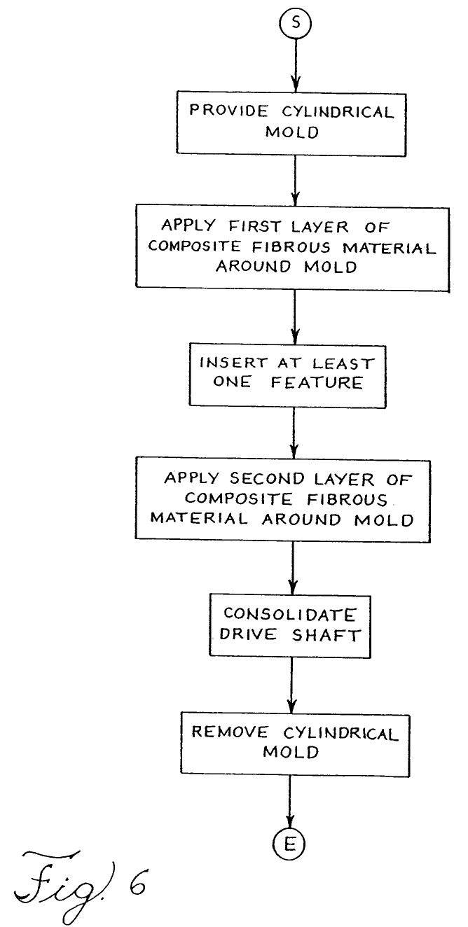

A particular embodiment of this invention includes a plurality of ring-section shaped features 21 arranged around the composite drive shaft 30 to form a ring. Such an embodiment is illustrated in the cross-sectional view of FIG. 7. A plurality of ring-section shaped features 21 are placed around the circumference of the composite drive shaft 30. Together, they form a ring around the shaft. This is better viewed in FIG. 8, where such a composite shaft is shown without the second layer of composite fibrous material 36. This ring shape has more features 21 for greater strength. The shape of the head pieces 20 of the features 21 helps to distribute the stress forces in a torsional stress. This allows the composite drive shaft 30 to withstand the stress that it undergoes during the process of swaging.

Although the invention herein has been described in connection with a preferred embodiment thereof, it will be appreciated by those skilled in the art that additions, modifications, substitutions, and deletions not specifically described may be made without departing from the spirit and scope of the invention as defined in the appended claims.

1. A composite drive shaft comprising:
a cylindrical shaft body;
plurality of features, said features perpendicular to the axis of said cylindrical shaft body, said features comprising a head piece and an anchor piece; and
composite fibrous material extending around said shaft body and said features to secure said features to the shaft body.

2. The composite drive shaft of claim 1, wherein said features further comprise metallic material.

3. The composite drive shaft of claim 1, wherein the shape of said head piece of at least one feature is selected from the group of: pins, studs, fasteners, and ring members.

4. The composite drive shaft of claim 1, wherein at least one of said anchor pieces further comprise a pin.

5. The composite drive shaft of claim 1, wherein at least a portion of said anchor piece further comprises at least one selected from the group of: hook, fin, screw threading, or knurled edges.

6. A method for making a composite drive shaft, said method comprising the steps of:
providing an elongated, cylindrical mold;
applying a first layer of composite fibrous material circumferentially around said mold;
inserting at least one feature radially through the first layer of composite fibrous material, said features comprising a head piece and an anchor piece;
applying a second layer of composite fibrous material over said first layer of composite fibrous material and at least one feature;
consolidating the drive shaft; and
removing the cylindrical mold from the drive shaft.

7. The method of claim 6, wherein said cylindrical mold further comprises at least one receiving groove.

8. The method of claim 7, wherein said anchor piece of said features is inserted into said receiving grooves.

9. The method of claim 8, wherein said step of applying a first layer of composite fibrous material further comprises the steps of:
providing one or more sheets of a preimpregnated resinous composite fibrous material; and
wrapping said sheets around said mold and any layers that may be underneath them.

10. The method of claim 8, wherein said step of applying a second layer of composite fibrous material further comprises the steps of:
providing one or more sheets of a preimpregnated resinous composite fibrous material; and
wrapping said sheets around said mold and any layers that may be underneath them.

11. The method of claim 8, wherein the shape of at least one feature is selected from the group of: pins, studs, fasteners, and ring members.

12. The method of claim 8, wherein the shape of at least one feature is a ring shape, and said feature is placed circumferentially equidistant around the shaft.

13. The method of claim 8, wherein said step of insertion of at least one feature further comprises: manually pushing said feature into the first layer of composite fibrous material.

14. The method of claim 8, wherein said step of insertion of at least one feature further comprises: using a mechanical device to push said feature into the first layer of composite fibrous material.

15. The method of claim 8, wherein said step of consolidation of the drive shaft further comprises utilizing at least one method from the group of: curing, shrink-wrapping, vacuum-bag consolidating, bladder mold pressurizing, or female-mold pressurizing.

16. The method of claim 8, wherein said at least one feature further comprises metallic material.

17. The method of claim 8, further comprising the step of applying an adhesive substance around the feature, prior to the application of the second layer of composite fibrous material.

18. A method for making a composite drive shaft, said method comprising the steps of:
providing an elongated, cylindrical mold, said mold defining at least one receiving groove;
inserting at least one feature radially into said receiving grooves in said mold, said feature comprising a head piece and an anchor piece;
applying a first layer of composite fibrous material circumferentially around said mold and said feature;
pushing said head piece of said feature through the first layer of composite fibrous material;
applying a second layer of composite fibrous material over said first layer of composite fibrous material and said features;
consolidating the drive shaft; and
removing the cylindrical mold from the drive shaft.

19. The method of claim 18, further comprising the step of applying an adhesive material around said feature.

20. The method of claim 19, wherein said adhesive material further comprises an epoxy-based adhesive.
